(19) United States
(12) Patent Application Publication
(10) Pub. No.: US 2012/0029994 A1
(43) Pub. Date: Feb. 2, 2012

(54) COUPON ORGANIZATION USING A BAR CODE READER

(75) Inventors: Edward Barkan, Miller Place, NY (US); Robert Sanders, St. James, NY (US)

(73) Assignee: Symbol Technologies, Inc., Holtsville, NY (US)

(21) Appl. No.: 12/844,891

(22) Filed: Jul. 28, 2010

(51) Int. Cl. G06Q 30/00; H04W 88/02

(52) U.S. Cl. 705/14.25; 705/14.27; 705/14.38; 705/14.1; 455/556.1

(57) ABSTRACT

A consumer can use his or her cell phone to scan barcodes from newspaper circulars at home, on a computer screen at home and/or to scan coupon barcodes positioned on the edge of shelves in a store or displayed on a kiosk in a store. The data from all these coupons is be combined into (preferably) a single 2D barcode or in the event of a large number of coupons, into a smaller number of 2D barcodes on the cell phone's display, for scanning by an imaging barcode scanner at the point of sale. This 2D barcode can also include the user's loyalty card information, so reading a single barcode off the screen of the phone can accomplish what formerly required multiple individual scans to accomplish.

### TECHNICAL FIELD

The present disclosure relates to a system comprising a method and apparatus for imaging and interpreting discount coupons using a portable communications device such as a cell phone.

### BACKGROUND

Existing barcode readers can be either handheld or stationary. When used at a point of sale checkout station, target objects, e.g., a product package that includes a target barcode, are brought within a field-of-view (“FOV”) of the barcode reader. Bar code readers can also image and interpret a coupon the customer has clipped at home and brought to the store.

For a handheld reader the user aims a visible aiming pattern to strike the package at a region of the barcode. In stationary bar code readers the product is moved through a stationary field of view. Once a bar code is properly identified, the barcode reader typically provides an audible and/or visual signal to indicate the target barcode has been successfully imaged and decoded and an item identifier and price displayed on a point of sale display.

Both stationary and portable imaging-based barcode readers include at least one camera or scan engine. A typical scan engine has a pixel array having photosensitive elements such as a charge coupled device (CCD) or complementary metal oxide semiconductor (CMOS) device. The scan engine also typically includes an illumination system having light emitting diodes (LEDs) or a cold cathode fluorescent lamp (CCFL) that directs illumination toward a target object, e.g., a target bar code. Light reflected from the target bar code is focused through a lens located near or on the scan engine by an imaging system such that focused light is concentrated onto the pixel array of photosensitive elements. The pixels of the array are sequentially read out by the scan engine, generating an analog signal representative of a captured image frame. The analog signal is amplified by a gain factor and the amplified analog signal is digitized by an analog-to-digital converter. Decoding circuitry of the imaging system processes the digitized signals and decodes the imaged bar code.

Various systems have been devised for delivering coupon barcodes to a cell phone screen for point of sale scanning in a store. None, however, combine this capability with the ability to eliminate a need for clipping, collecting and scanning paper coupons. Some stores provide coupon dispensers mounted to edges of shelves (such as those supplied by New America). This requires printing paper coupons, service employees to replenish coupons, loss of sales due to coupon outages, loss of coupons due to children pulling out large numbers of coupons from a dispenser etc.

United States Published application 2008/0183576 concerns a mobile service system using a two-dimensional coupon code. A user captures the two-dimensional coupon code printed on a coupon and transmits the captured two-dimensional coupon code to a server, and captures a two-dimensional store code printed on a store medium and transmits the captured two-dimensional store code to a server, using his or her cellular phone. The server transmits data that allows the user to use a coupon to the user's cellular phone, and the data is inputted into a terminal of a store to use the coupon.

### SUMMARY

An exemplary system allows information that corresponds to one or more discount coupons to be stored in a portable communications device such as a cell phone and redeemed at a point of sale terminal by reading a bar code off from a display.

A consumer can use his or her cell phone to image barcodes from newspaper circulars at home, on a computer screen at home and/or to scan coupon barcodes positioned on the edge of shelves in a store or displayed on a kiosk in a store. The data from all these coupons can be combined into (preferably) a single 2D barcode or in the event of a large number of coupons, into a small number of 2D barcodes and then displayed on the cell phone's display, for scanning by an imaging barcode scanner at the point of sale. This 2D barcode can also include the user's loyalty card information, so reading a single barcode off the screen of the phone can accomplish what formerly required multiple individual scans to accomplish.

The invention greatly simplifies use of coupons clipped out of newspapers, gathered from shelf dispensers in the store and/or received electronically for display on a cell phone for scanning at a point of sale scanner in a store. The prior art check out process is cumbersome and time consuming A consumer presents multiple paper coupons to the store check-out clerk, as well as presenting a barcode loyalty card for scanning, and also presenting multiple bar codes on a cell phone screen which have to be individually scanned. In accordance with the invention all this information can be greatly condensed into for example one bar code. In the exemplary system this is a 2D bar code and could in the case of many coupons be a few 2D bar codes.

Additionally, the prior art does not allow customized discounts or other offers based on the buying habits of the consumer. For example a retailer may wish to grant larger discounts to loyal shoppers, or to shoppers who have previously made purchases above a threshold dollar value. This information can also be condensed into the bar code presented for scanning that also contains the coupon identifying information. These and other advantages and features of the invention are described in greatly detail with respect to an exemplary embodiment of the invention.

### BRIEF DESCRIPTION OF THE DRAWINGS

The foregoing and other features and advantages of the present disclosure will become apparent to one skilled in the art to which the present disclosure relates upon consideration of the following description of the invention with reference to the accompanying drawings, wherein like reference numerals, unless otherwise described refer to like parts throughout the drawings and in which:

FIG. 1 is a perspective view of a bar code reader having a scan engine for imaging a display or a portable communications device;

FIG. 2 is a schematic depiction of components of a portable communications device such as a cell phone;

FIG. 3 is a perspective view of a portable communication device imaging a discount coupon;

FIG. 4 is schematic depiction of components of an image based bar code reader;

FIG. 5 is a schematic depiction of a network for communicating coupon related information amongst communications devices that access the network;

FIG. 6 is a flowchart of one exemplary process for coupon capture using a portable communications device.

### DETAILED DESCRIPTION

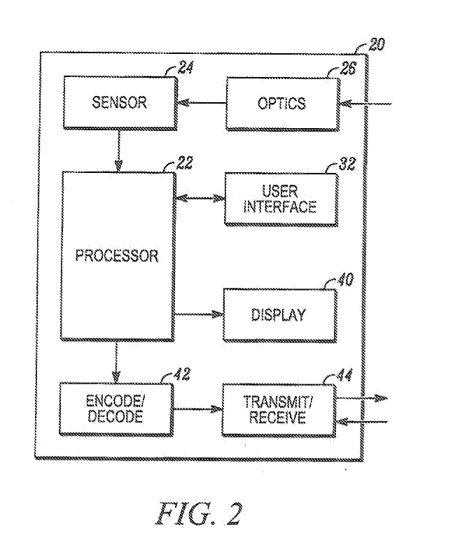

The figures depict a system for organizing, imaging and giving credit to customers for discount coupons by presenting coupon information on a display of a portable communications device 20 such as a cell phone or other hand held communications device. The device 20 has the ability to take pictures. The exemplary device 20 includes a controller 22 (FIG. 2) having a memory and an image sensor 24 coupled to optics 26 for capturing an image of a discount coupon 30. The device 20 has a user controlled actuator forming part of a user interface 32 that signals the controller to capture an image of the coupon. The device also includes a display screen 40 for presenting an image corresponding to the discount coupon. The exemplary device 20 can send and receive voice signals and therefore also includes encode/decode circuitry 42 and a transceiver 44.

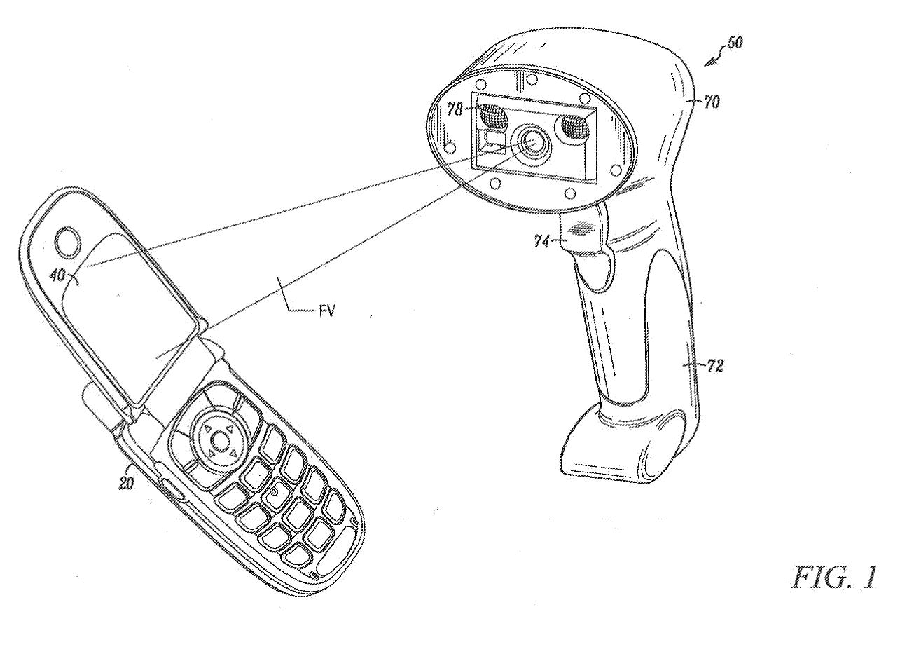

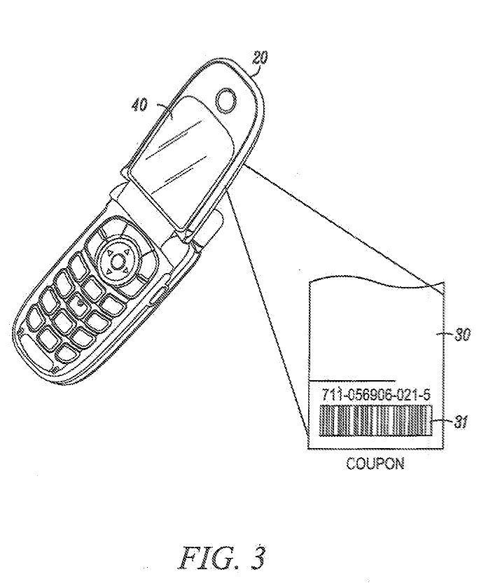

As seen in FIG. 3 a consumer can use the device 20 to image barcodes from newspaper circulars at home, on a computer screen at home and/or to image a coupon 30 having a barcode 31 positioned on the edge of shelves in a store or displayed on a kiosk in a store. Each coupon typically contains a 1D barcode that is unique to the coupon. The data from all these coupons can be combined into (preferably) a single 2D barcode or in the event of a large number of coupons, into a smaller number of 2D barcodes on the cell phone's display, for imaging by an imaging barcode reader 50 (FIG. 1) at the point of sale. In one embodiment the 2D barcode can also include the user's loyalty card information, so reading a single barcode off the screen of the device 20 can accomplish what formerly required many individual reader scans to accomplish.

The process of encoding a 2D bar code is described in detail in U.S. Pat. No. 5,243,655 to Wang which issued Sep. 7, 1993 and which is incorporated herein by reference for all purposes. The '655 patent describes the PDF417 bar code specification and describes how data is encoded into this type of 2D bar code. PDF417 is capable of encoding more than 1100 bytes, 1800 text characters or 2710 digits. Large data files can be encoded into a series of linked PDF417 symbols using a standard methodology referred to as Macro PDF417. Further details describing encoding of information into a 2D barcode are available in ISO standard 15438.

The controller 22 contains software for determining the information contained within the individual 1D barcodes 31 on the coupon 30 and converts that information for encoding into the 2D format. In one embodiment the controller 22 separates the information for each coupon with a special ASCII delimiter that signals the end of information for one coupon and the beginning of information to a next subsequent coupon. The 1D information includes designating information regarding the product (SKU number, for example) it is associated with as well as a supplier designator so that the store's point of sale reader 50 can properly credit the purchaser if the coupon and product are presented during the same sales transaction.

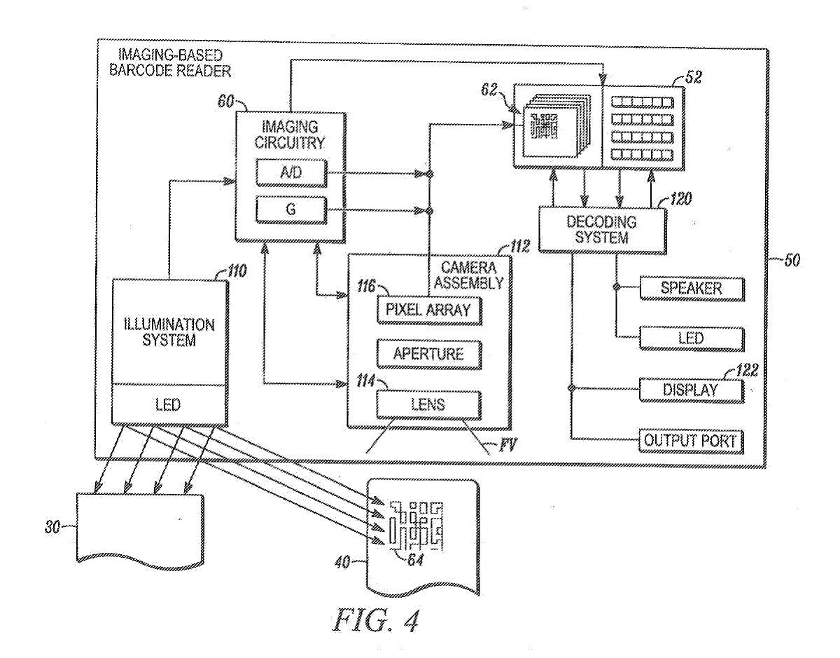

FIG. 1 depicts a point of sale bar code reader 50 capable of capturing an image of the display screen 40 of the portable communications device 20 within the reader imaging field of view FV. The reader includes illumination and imaging optics that form the field of view FV for imaging a target object. FIG. 4 is a schematic depiction of reader components including a memory 52 and imaging circuitry 60 that acquires and stores captured images 62 from the display screen 40 of the portable communications device within the field of view. The reader decodes bar codes within the field of view and specifically decodes barcodes 64 corresponding to multiple coupons that were previously imaged. In one embodiment the reader 50 transmits the information contained in the barcode 64 for evaluation by a point of sale computer 66 coupled to the reader 50. The computer 66 gives the customer a discount at the point of sale once the point of sale computer identifies the item or items associated with the coupon and confirms that the item has also been presented for purchase.

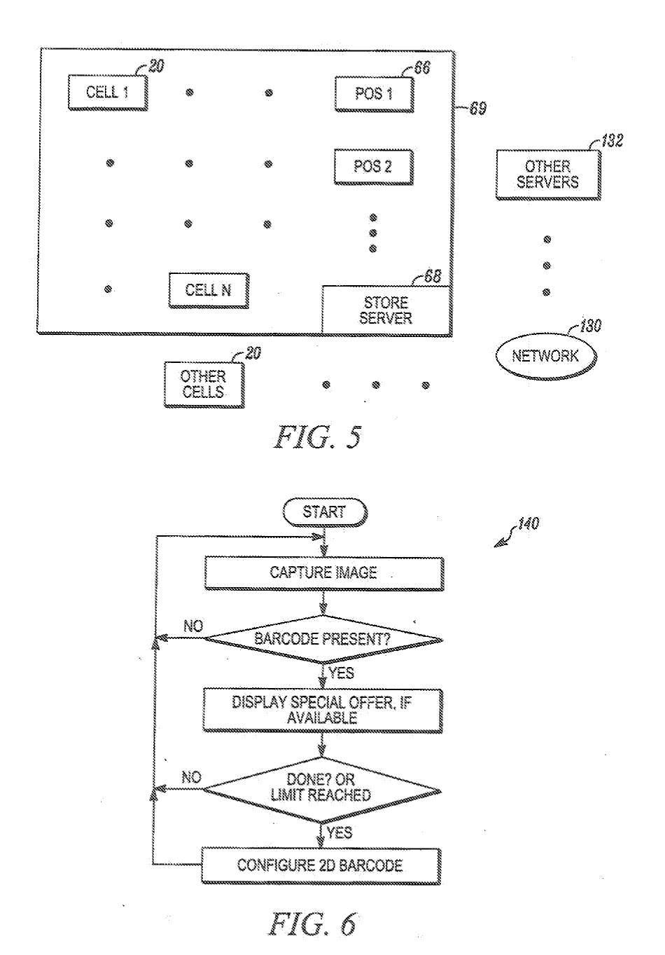

The store may include multiple portable or stationary point of sale bar code readers (FIG. 5) all coupled through an in store network to a store server 68 within a store 69. A portable reader 50 is shown in FIG. 1. It has a housing having a head 70, handle 72, and an optional trigger 74. Located in the housing is a protective window for protecting an imaging subsystem or scan engine 78.

The scan engine 78 projects an aiming pattern toward a target bar code 64 (or bar codes) on the display 40 and attempts to decode that bar code to extract coupon information. The reader may also be aimed at a coupon 30 within the reader field of view for interpreting a 1D barcode on the coupon. The process of decoding a barcode is well known in the art. The scan engine 78 comprises a chassis that supports a printed circuit board (not shown). Attached to the printed circuit board are several optical components that include, illumination optics 110, aiming optics for generating the aiming pattern, and imaging optics 112. Each of the optical components have a designed field-of-view for projecting or receiving light directed during operation. Also coupled to the printed circuit board are various electrical components that assist in imaging and decoding the bar codes on the display 40. The imaging optics 112 includes focusing lens or lenses 114 that focus the reflected image from the display 40 onto a sensor array 116 located behind the focusing lens(es). An aiming pattern is generated by a laser diode (not shown) and facilitates a user in locating a center of the captured image.

When enabled by a controller 60 (FIG. 4), the imaging optics 112 captures an image frame of a field of view FV of the reader 50. When imaging a target bar code 64, the imaging process may need to capture and store in the memory a series of image frames 62 (FIG. 4) in response to multiple user actuations of the trigger. A decoding system 120 analyzes each image frame of the series of image frames 62 and attempts to decode the imaged bar code. All or portions of the images may be stored in a the memory 52.

The bar code reader circuitry is electrically coupled to a power supply, which may be in the form of an on-board battery or a connected off-board power supply. If powered by an on-board battery, the reader 10 may be a stand-alone, portable unit as depicted in FIG. 1. If powered by an off-board power supply, the reader 10 may have some or all of the reader's functionality provided by a connected host computer 66. Circuitry associated with the imaging and decoding systems 60, 120 may be embodied in hardware, software, firmware, electrical circuitry or any combination thereof and may be disposed within, partially within, or external to a reader housing. The reader 50 also includes a display 122 which in the instance of a stationary reader includes a display which enables the customer to view messages relating to discounts and special offers appearing on the reader display.

The sensor array 116 may comprise a charged coupled device (CCD), a complementary metal oxide semiconductor (CMOS), or other imaging pixel array, operating under the control of the imaging circuitry 24. In one exemplary embodiment, the pixel array 150 comprises a two dimensional (2D) mega pixel array with a typical size of the pixel array being on the order of 1280×1024 pixels.

During an imaging session, multiple images of the field of view FV may be obtained by the imaging system 10. An imaging session may be instituted by an operator, for example, pressing the trigger 74 to institute an imaging. Alternately, for a stationary imaging system, an imaging session might start when a lower or bottom edge of an item begin to move through a portion of the field of view FV. After an exposure period, some or all of the pixels of pixel array 116 are successively read out by the controller 60, thereby generating an analog signal scaled by a gain factor which is converted by an analog to digital converter that forms part of the controller 60. In some sensors, particularly CMOS sensors, all pixels of the pixel array 116 are not exposed at the same time, thus, reading out of some pixels may coincide in time with an exposure period for some other pixels. The digitized signal comprises a sequence of digital gray scale values typically ranging from 0-255 (for an eight bit processor, i.e., 2⁸=256), where a 0 gray scale value would represent an absence of any reflected light received by a pixel (characterized as low pixel brightness) and a 255 gray scale value would represent a very intense level of reflected light received by a pixel during an integration period (characterized as high pixel brightness).

FIG. 6 is a flowchart 140 of one system implemented by a processor of the portable communications device 20. Since the user can be identified by his or her customer loyalty information which may be included in the barcode 64 displayed on the display, discounts or offers can be customized for that customer. Furthermore, the phone can contain information about the discount level available to that consumer and therefore be able to display to the consumer information about how much he or she will save based on that information, should he purchase that product. The consumer can then decide if they wish to buy that product. This ‘discount level’ information can be loaded into the phone wirelessly through a network 130 directly from a retailer server 132 when the consumer achieves the desired threshold, or can be loaded by scanning a barcode that was mailed to the consumer or made available to them in the store 69.

An additional possibility is to provide special offers, such as accessories for a particular product only if that specific product is purchased. The phone 20 can contain offer information (received wirelessly from the retailer) that is presented to the consumer upon scanning the shelf label associated with the product that has the special offer, or the phone display can prompt the consumer to buy that product because the special off is available. Should the consumer decide to avail himself of the offer by buying the product, the 2D barcode 64 that is ultimately imaged at the point of sale will include the special discount or offer information, so the consumer will automatically receive the special discount.

Another possibility is to use the phone simply to capture images of paper barcodes or barcodes displayed on a home computer or by a kiosk in the store and to re-display them individually for scanning in the store. This requires no application software in the phone, and no special software running on the store point of sale system since the store scanner will simply interpret the displayed images as the original paper coupons (or displayed coupons). This last option has the benefit of eliminating the need to clip and collect paper coupons.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A portable communications device comprising a controller, a camera for capturing an image of a discount coupon, a memory for storing data, and a display screen; the communications device having a user controlled actuator that signals the controller to capture an image of a discount coupon and for presenting an image corresponding to the discount coupon on the display screen; said controller converting information from multiple bar codes from multiple discount coupons into at least one combined bar code for presentation on the display screen.

2. The apparatus of claim 1 wherein the portable communications device memory stores customer loyalty information and wherein a bar code displayed on the display screen of the portable communications device contains customer loyalty information.

3. The apparatus of claim 1 wherein the portable communications device memory stores user information and wherein a bar code displayed on the display screen of the portable communications device contains user information.

4. The apparatus of claim 1 wherein the portable communications device displays a discount level available to a consumer to inform the consumer about how much he or she will save based on that information in the event a product is purchased.

5. The apparatus of claim 4 wherein the discount level information is transmitted to the portable communications device by a retailer based on past consumer purchasing activity.

6. The apparatus of claim 1 wherein the portable communications device displays information that is received wirelessly from a retailer upon imaging a shelf label associated with the product that has a special offer and wherein the portable communications device prompts the consumer to indicate the special offer is available.

7. A method for organizing coupons with a portable communications device having a memory for storing data and a device camera comprising:
storing multiple depictions of multiple discount coupons that are either transmitted from a remote site or captured using a device camera;
converting identifying information from multiple discount coupons into a combined bar code;
at a point of sale location, presenting the combined bar code on a portable communications device display screen.

8. The method of claim 7 wherein a portable communications device controller converts identifying information from a 1D bar code contained in a discount coupon and combines the identifying information from multiple coupons into at least one 2D bar code of the combined bar code for presentation on the display screen for evaluation at a point of sale by a bar code reader.

9. The method of claim 7 comprises storing customer loyalty information in a device memory and wherein a bar code displayed on the screen of the portable communications device also contains customer loyalty information.

10. The method of claim 7 comprises storing user information in a device memory and wherein a bar code displayed on the screen of the portable communications device also contains user information.

11. The method of claim 7 additionally wherein a point of sale bar code reader displays discount information or options based on the combined bar code displayed by the portable communications device at a point of sale.

12. The method of claim 7 wherein the portable communications device displays information that is received wirelessly from a retailer upon imaging a shelf label associated with the product that has a special offer and wherein the portable communications device prompts the consumer indicating the special offer is available.

13. A portable communications device comprising a controller, a camera for capturing an image of a discount coupon, a memory that stores customer information, a display, and a user controlled actuator that signals the controller to capture an image of at least one discount coupon having a bar code and display an image containing a new bar code on the display, wherein the new bar code includes both information related to the at least one discount coupon and the customer information from the memory.

14. The portable communications device of claim 13 wherein the coupon contains a 1D bar code and the new bar code is a 2D bar code.

15. The apparatus of claim 13 wherein said controller converts identifying information from multiple bar codes from multiple discount coupons into an additional bar code for presentation on the display screen.

16. The apparatus of claim 13 wherein the portable communications device displays the discount level available to a consumer to inform the consumer about how much he or she will save based on that information in the event a product is purchased.

17. The apparatus of claim 16 wherein the discount level information is loaded into the portable communications device from a retailer based on past consumer purchasing activity.

18. The apparatus of claim 13 wherein the portable communications device displays information that is received wirelessly from a retailer upon imaging a shelf label associated with the product that has a special offer and wherein the portable communications device prompts the consumer indicating a special offer is available.

19. A method for organizing coupons with a portable communications device having a memory for storing data and a device camera comprising:
storing at least one depiction of a discount coupon that is either transmitted from a remote site or captured using a communications device camera;
storing customer information for use in a database system coupled to a point of sale reader in the device memory; and
combining information related to the at least one discount coupon and the customer information within a bar code and displaying the bar code on a portable communications device display.

20. The method of claim 19 additionally comprising converting bar code identifying information from one or more discount coupons into a reconfigured bar code and displaying said reconfigured bar code that includes the customer information on the device display.

21. The method of claim 19 wherein the customer information is customer loyalty information that is presented on the display as part of the bar code.

22. The method of claim 20 wherein the portable communications device reconfigures 1D bar code information from more than one discount coupon into a single 2D bar code for presentation on the device display.

23. The method of claim 19 wherein the portable communications device displays a discount level available to a consumer to inform the consumer about how much he or she will save based on that information in the event a product is purchased.

24. The method of claim 23 wherein the discount level information is loaded into the portable communications device wirelessly from the retailer.

25. The method of claim 23 wherein the discount level is loaded into the portable communications device by imaging a barcode mailed to the consumer or made available to them in the store.

26. The method of claim 19 wherein the portable communications device displays information that is received wirelessly from a retailer upon imaging a shelf label associated with the product that has a special offer and the portable communications device prompts the consumer indicating the special offer is available.

27. The method of claim 26 wherein in the event a consumer decides to avail themselves of the special offer by buying the product, a barcode that is ultimately scanned at the point of sale includes the special discount so the consumer will automatically receive the special discount on their purchase.
